(19) United States
(12) Patent Application Publication
(10) Pub. No.: US 2002/0105536 A1
(43) Pub. Date: Aug. 8, 2002

(54) Method and apparatus for administering interactivity for elements of a video sequence

(75) Inventors: Tilman Hampl, Waldbuttelbrunn (DE); Winfried Piegsda, Eggenstein-Leopoldshafen (DE); Ralph Sonntag, Kunzell (DE)

Correspondence Address: MICHAEL BEST & FRIEDRICH, LLP, 100 E WISCONSIN AVENUE, MILWAUKEE, WI, 53202, US

(73) Assignee: active-film.com AG, Frankfurt am Main (DE)

(21) Appl. No.: 09/930,391

(22) Filed: Aug. 15, 2001

(30) Foreign Application Priority Data
Aug. 16, 2000 (EP) 00117655.1

(51) Int. Cl. G09G 5/00

(52) U.S. Cl. 345/723

(57) ABSTRACT

The invention relates to a method and an apparatus for computer controlled administration of interactivity for elements of a video sequence wherein the element is an audio, visual or content-related element. The activatability in time is recorded for an element and an activatable object for a reproduction platform having a specific format for video sequences is created wherein different reproduction platforms are supported, the format-specific creation is performed based on the activatability in time as well as preset parameters for activation properties and the activatable objects are positionally arranged based on the preset parameters.

### BACKGROUND OF THE INVENTION

1. Field of the Invention

The invention relates to a method and an apparatus for computer-controlled administration of interactivity of a video sequence's elements according to the preamble part of claim 1.

2. Description of the Related Prior Art

Due to the economic interests of the marketing and sales department to guide a customer to products or information thereon in a simple or attractive manner, the increasing number of different reproduction platforms for video sequences and the possibility to receive video sequences over the Internet, interactivity in video sequences becomes a major factor in the processing of video sequences.

FIG. 1 illustrates the basic principles of creating interactivity for elements 11, 12 or 15 of a video sequence 10. The video sequence 10 comprises, for example, a picture sequence 13 and an audio sequence 14. In an interactivity creation unit 20 activation properties 21 and 22 are determined for the elements 11 and 12 respectively and activatable objects 31 and (12+22) are created. The activatable objects 31, (12+22) are incorporated into the video sequence 10 for providing interactivity in a reproduction platform 30. Therein the picture sequence 13 is displayed in a displaying unit 33 with the activatable object 31 and the activatable area 22, whereas the audio sequence 14 is reproduced as a sequence of sounds by means of the audio reproduction unit 34. A non illustrated viewing person may activate the activatable object 31 or (12+22) by means of actions with an indicating unit 35. The activation properties 21, 22 can comprise different events for various actions of the viewing person, which will in the following also be denoted as content related activatability. If the viewing person points to an activatable object by means of the indicating unit 35 an informative text for the element 11 may be displayed. If the viewing person upon pointing presses a button on the indicating unit 35, a non-illustrated short intermediate video sequence comprising further activatable objects may be displayed. After the end of the short video sequence, the reproduction of the video sequence 10 may be continued.

The elements of a video sequence as indicated in FIG. 1 may be visual (building 11) or audio (sound sequence 12) but even content related (for example, happiness or friendship). The common methods for creating interactivity for elements in a video sequence are directed to visual elements.

A prior art method for administering interactivity of elements of a video sequence is illustrated in FIG. 4. In the creation unit 20 for an element of the video sequence 10, that should be activatable, the positional arrangement of the element is determined in a unit 25 for recording co-ordinates and the positional arrangement of the element in its temporal development is determined by means of a movement recording unit 24. In a units 26 the activation properties for the elements are determined. Together with the positional information from the units 24 and 26, the activation properties are incorporated into the video sequence in an inserting unit 23. Depending on the requirements for the reproduction platform 30, the video sequence 10 is either transferred to the reproduction platform 30 with its inserted activatable objects or separated thereof.

For determining the movement of an element, different methods all comprising major disadvantages are known in the prior art. Upon the manual processing, activation properties have to be assigned to the element picture by picture or frame by frame. Such manual processing requires an enormous amount of work with various possibilities for errors. In semi-automatic processing, the activatable object is created only for a selection of main frames of the video sequence. Then, the movement of the element between those main frames can be automatically calculated, as long as the elements move in a mathematically simple to define manner. Thereby the necessary manual processing is reduced upon an increased calculation amount. Based on a basic pattern of the element, a pattern recognition method can automatically record the element picture by picture and thereby trace the movement of the element in the video sequence. The pattern recognition becomes particularly difficult by the fact that the element is changeable in its representation in the video sequence. Thus, even for simple video sequences an enormous calculation amount becomes necessary. A pattern recognition, for example, for a specific person wherein the shown part, the perspective or the person's deportment changes, becomes extremely difficult.

TABLE 1
An example for positional information of a video sequence's element.

| | | | Picture | | | | | |
|---|---|---|---|---|---|---|---|---|
| Element | Xₛ | Yₛ | 0 | 1 | 2 | 3 | . . . | end |
| 1 | X₁(0) | Y₁(0) | X₁(0) | X₁(0) | X₁(0) | X₁(0) | . . . | X₁(0) |
| | | | Y₁(0) | Y₁(0) | Y₁(0) | Y₁(0) | | Y₁(0) |
| 2 | X₂(2) | Y₂(2) | − | − | X₂(2) | X₂(2) | . . . | − |
| | | | | | Y₂(2) | Y₂(2) | | |
| 3 | X₃(1) | Y₃(1) | − | X₃(1) | X₃(2) | X₃(3) | . . . | − |
| | | | | Y₃(1) | Y₃(2) | Y₃(3) | | |
| 4 | X₄(0) | Y₄(0) | X₄(0) | . . . | . . . | X₁(0) | . . . | − |
| | | | Y₄(0) | | | Y₁(0) | | |
| 5 | X₅(3) | Y₅(3) | − | − | − | X₁(0) | . . . | − |
| | | | | | | Y₁(0) | | |
| 6 | − | − | − | + | + | + | . . . | − |

Table 1 illustrates recorded positional information, for an example of six elements. The first column comprises the number of the element, the second and third columns the co-ordinates of the element upon its first appearance in the video sequence. The following columns indicate the co-ordinates of the element in its development in time, displayed picture by picture or frame by frame. If an element does not exist for a specific time in the video sequence, the respective cell is marked with ,,−”.

Element 1 is the only element which is displayed over the entire video sequence and that does not move (X₁(picture)=X₁,(0); Y₁(picture)=Y₁(0)). Element 2 is visible in the video sequence starting from picture 2, but also does not move. Element 3 starting from picture 1 moves through the video sequence very fast and is visible therein only for a short period of time. To the contrary, element 4 only slowly moves from its starting position to the position of element 1. Element 5 is a content related element, which exists as long as element 4 is at the position of element 1. The co-ordinates of element 1 are assigned thereto. Element 6 is an audio element and thus does not have co-ordinates. In table 1 ,,+” is inserted for element 6 as long as it is present.

A further problem arises, if an element which shall be activated is visible in the video sequence for a time too short or the movement of the element too fast for being recognised or activated by a viewing person. Depending on the viewing person and the reproduction platform, such a maximum suitable velocity or the minimum suitable visibility for an element which shall be activitable may vary. Reproduction platforms, for example, may differ in the screen size, resolution, reproduction speed, activation possibilities, operating system, computer program for reproduction of the video sequence or different versions thereof.

If one assumes, for the example of the elements in Table 1, a minimum suitable visibility of 4 pictures or frames, then the elements 2, 3 and 5 are visible for a period of time being too short for being activated by a viewing person. Additionally, one can assume that element 3 moves too fast to be activatable by a viewing person.

Due to the possible differences between reproduction platforms, a video sequence should be adapted to the specific format for the reproduction platform. An existing video sequence with activatable objects can be converted for different reproduction platforms with certain limitations only. Contrary thereto, a format-specific creation of different versions of the video sequence for different reproduction platforms in the prior art method (FIG. 4) requires the repetition of the work-intensive steps of the method.

### SUMMARY OF THE INVENTION

It is the object of the invention to provide a method and an apparatus allowing the simplified administration of interactivity for elements of a video sequence and simplified or faster creation of activatable objects for reproduction platforms having different formats.

According to the invention, this object is solved by a method according to claim 1.

The dependent claims describe preferred embodiments of the invention. According to the invention, the activatability in time is recorded for an element and an activatable object is created for a reproduction platform having a specific format for video sequences, wherein according to the invention the format-specific creating is performed based on the activatability in time as well as preset parameters for activation properties. Furthermore, the activatable object is positionally arranged based on the preset parameters and for the step of creating a variety of reproduction platforms are supported. Thereby, an activatable object can be created for an element without the need to record the positional arrangement or the movement of the element. The video sequence has to be processed only once for the recording of the activatability in time of the element before an activatable object can be created, when activation properties are already known for this element.

Preferably, for the step of creating, it is predetermined to use a selectable text or an activatable area as a representative of the element, the representative being positionally arranged independently from the element. Besides positionally associating the representative to the element, furthermore the recording or determination of a representative is omitted. Thereby a simple and fast creation method for a video sequence having activatable objects is achieved.

According to a preferred embodiment of the method, the activatability in time and activation properties for the element are administered separated from the video sequence. Thus, an improved support for the step of creating for different reproduction platforms is achieved.

According to a further preferred embodiment of the method, the activation properties and the activatability in time is stored in an external database separated from each other but associated to each other by reference. The activation properties and the activatability in time in the external database can be changed easily and simply as well as clearly arranged in the form of a list.

It is particularly advantageous if the preset parameters for the activation properties comprise general and format-specific parameters, which can be stored in an external database. The general parameters render the recycling of activation properties for an element in further video sequences if, for example, the element exists in different video sequences or if basic activation properties of an element can be recycled. Format-specific parameters consider the properties of the reproduction platform for video sequences having activatable objects.

According to a preferred embodiment of the method, the step of recording the activatability in time for an element is performed by setting a time stamp or timing mark in response to an action of a processing person upon reproduction of the video sequence. Thereby, an effective solution for recording the activatability in time is provided.

Upon a further embodiment of the invention, the step of creating activatable objects is realised by using an export filter performing or analysing an importancy factor of the preset parameters and the activation properties for the video sequence. By means of importancy factors, relative preset parameters can be realised, which remain flexible for specific cases. For a once created video sequence having activatable objects, the export filter renders the creation of as many versions of the video sequence for different reproduction platforms as desired, only by specifying the specific format of the reproduction platform.

According to a preferred embodiment a computer controlled apparatus is used for realising one of the above methods. Thereby, short processing times and an optimised embodiment of the method become possible.

According to further embodiments, a computer storage medium comprises a computer program or an instruction sequence realising one of the above methods. Thus, a once implemented method can be used repeatedly and becomes transportable.

### BRIEF DESCRIPTION OF THE DRAWINGS

The enclosed figures illustrate:

FIG. 1 basic concept for creating interactivity of an element of a video sequence,

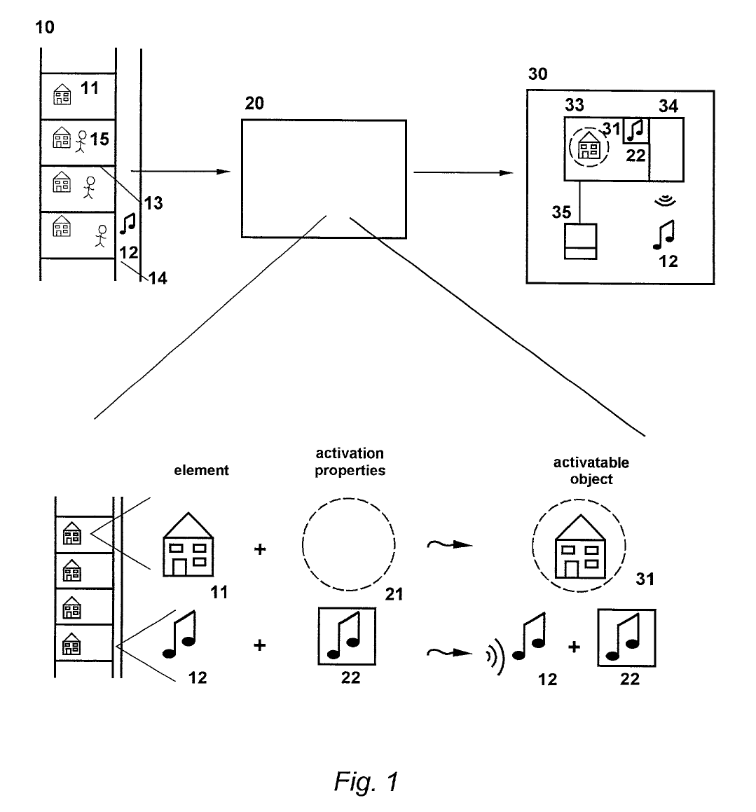

FIG. 2 a representation of a method according to the invention for creating activatable objects,

FIG. 3 a representation of a further preferred embodiment of the method for creating activable objects, wherein the activation properties of the elements are already known,

FIG. 4 a representation of a prior art method for administering interactivity of elements in a video sequence.

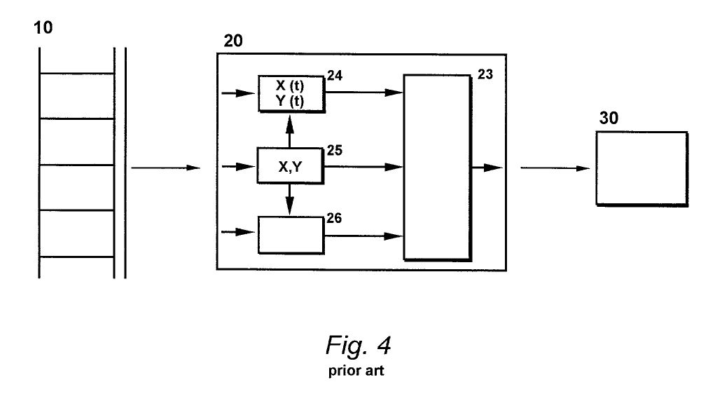

### DETAILED DESCRIPTION OF THE INVENTION

In the following, preferred embodiments of the invention are described with reference to the enclosed figures.

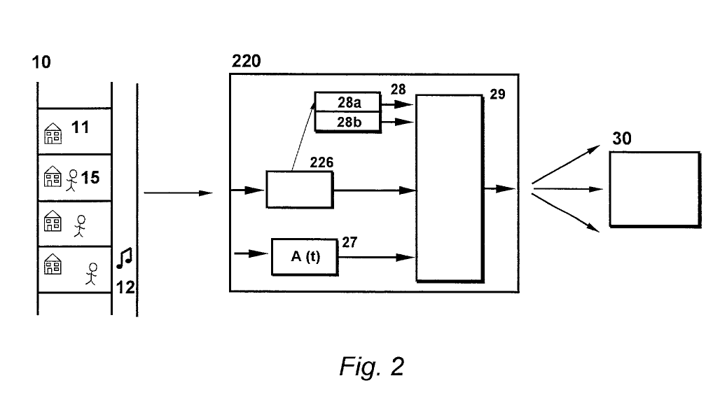

FIG. 2 illustrates a preferred embodiment of the invention. In a creation unit 220, interactivity is provided for a video sequence 10 having elements 11, 12 and 15 format-specific for a reproduction platform 30, which uses a specific format for the reproduction of the video sequence 10 having activatable objects.

The reproduction platform 30, for example, can be a computer, a mobile phone, a television having corresponding properties or a television in connection with a video reproduction unit. The creation unit 220 may be a part of a computer, a video processing interface or a movie processing unit. The existing unit essentially determines the embodiment of the method.

The computer particularly may comprise: a displaying unit, a keyboard, a mouse, a controlling unit, a hard disk and a drive for optical or magnetic storage medium. Further, the computer may be supplemented by the following units: a modem, a microphone, a loudspeaker and a digital camera. In the following, the computer comprising the stated supplements is assumed as a creation unit 220. A video sequence can particularly originate from digitising an optical and audio sequence and a following compression.

In the creation means 220, an activatability in time is recorded for the elements 11, 12 or 15 in an activatability unit 27. An activatable object for one of the elements 11, 12 or 15 is created in a specific format for the reproduction platform 30 in the insertion unit 29. According to the invention, the format-specific creation uses the activatability in time as well as preset parameters from the preset parameter unit 28. Therein the format-specific creation for different reproduction platforms is supported and the positional arrangement of the activatable object is determined based on the preset parameters. The format-specific parameters 28b from the preset parameter unit 28 render a format-specific creation for different reproduction platforms. If activation properties and the activatability in time for the element 11, 12 or 15 exists or is already stored in the insertion unit 29, the positional arrangement of an activatable object can be performed, for example, based on the following preset parameters:

activatable objects have to be arranged side-by-side in a displaying portion separated from the displayed video sequence 10, or

at most 4 activatable objects have to be arranged at the positions ,,top”, ,,bottom”, ,,right” and ,,left” in the video sequence, if the reproduction platform 30, for example, provides exactly 4 corresponding direction keys for activating activable objects.

If another preset parameter defines to use an activatable area having the name of the element as a representative for the element 11, 12 or 15, all conditions for the creation process are set. As a representative for the element 11,12 or 15 even a text, for example, the name of the element may be used to be selectable in the reproduction platform 30.

The activatability in time, for example can be determined or recorded as timestamps for the beginning and the end of a period of activatability as illustrated in Table 2 for the respective elements from Table 1. The time stamps preferably can be set in response to an action of a processing person (not illustrated) of a video sequence upon reproduction of the video sequence. For example, the processing person can set the time stamps for element 1 by pressing a press button associated to element 1, while the video sequence is reproduced particularly in real time. Since the activatability in time thereby remains easy to change and administer, it is stored separated from the video sequence in an external database.

TABLE 2
An activatability in time for the example from Table 1.

| element | tₛₜₐᵣₜ | t_{end} |
|---|---|---|
| 1 | Pict₀ | Pict_{end} |
| 3 | Pict₁ | Pict₅ |
| 4 | Pict₀ | Pict₄ |
| 5 | Pict₃ | Pict₆ |
| 6 | Pict₁ | Pict₄ |

Based on the example in Table 1, Table 2 illustrates an activatability in time for elements of a video sequence. For each activatable object, a starting time (tₛₜₐᵣₜ) and an end time (t_{end}) for the activatability of the object is given. Compared to Table 1, it can be recognised that the potentially activatable element 2 shall not be activatable. In response to a visibility of the elements 2, 3 and 5 being too short for an activation (see description for table 1), the activatability period for the elements 3 and 5 has been set to a minimum activatability period in time, which makes sense, of four frames. Thus, the activatability is independent from the parallel reproduction, for example visibility of the element. For one element, also multiple separated activatability periods are possible.

In the general parameters 28a from FIG. 2, for the element 11, 12 or 15 in a unit 226 for determining the activation properties, activation properties for the element 11, 12 or 15 fixed once can be stored for being recycled for further video sequences (not illustrated) comprising the same element 11, 12 or 15. If for example for the element 11, a music shop, multiple video sequences have to be processed to include activatable objects, the activation properties of the elements existing in more than one of these video sequences can be recycled. Furthermore, for example, standard products for the music shop 11, which are not included in the video sequence 10 but nevertheless should be offered, can be created based upon the general parameters 28a as an activatable object for the video sequence 10.

The activation properties for the element 11, 12 or 15 in the video sequence 10 are administered separately from the video sequence 10 in an external database. Besides the content activatability for the element 11, 12 or 15, the activation properties for example can comprise information about the representative for the element or about the positional arrangement of the element. Upon comparing the method according to the invention and the prior art method, it can be stated that according to the invention, the positional arrangement may be recorded optionally and thus for the example from table 1 only element 4 would be recorded in its positional arrangement because it moves slowly enough to be activated. Activation properties and activatability in time particularly can be stored in the same external database separated from each other but associated to each other for example by the element numbers.

The preset parameter unit 28 may be a local copy of an external database or comprise a selection of data therefrom. Depending on the reproduction platform 30, the activatable object is inserted into the video sequence 10 and transferred to the reproduction platform either separated therefrom or incorporated into the video sequence.

The reproduction platform 30 can receive the video sequence 10 having activatable objects in three different manners:

stored on a storage medium from a provider,

from a storage medium of the provider, transferred via the connection between the reproduction platform and the provider, or

via specific techniques for example Internet protocols as actual portions of the video sequence 10 at a time only, without the need to hold a local copy of the video

sequence 10 in the reproduction platform 30.

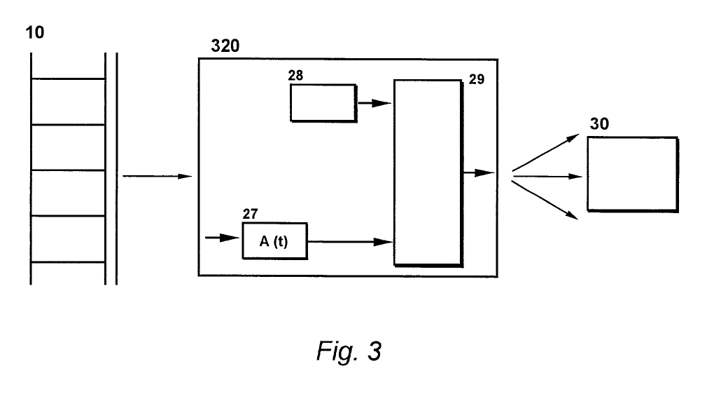

FIG. 3 illustrates a further embodiment of the invention, wherein the video sequence 10 having elements 11, 12, and 15 in the insertion means 320 is provided with activatable objects format-specific for a reproduction platform 30.

If, for the elements 11, 12 and 15 of the video sequence, activation properties already exist as general parameters in an preset parameter unit 28 after recording the activatability in time in an activatability unit 27, the creation of corresponding activatable objects can be performed in the insertion unit 29. The activation properties may be stored in the general parameters upon processing a similar video sequence comprising the elements 11, 12 or 15 as illustrated for FIG. 2.

The existing activation properties and the activatability in time for the video sequence are stored in an external database (not illustrated). The external database for example can be a part of the activatability unit 27, or provide a copy or a selection for the video sequence in the activation unit 27. For example, the preset parameters are stored in an external database (not illustrated) which can be a part of the preset parameter units 28 or provide a copy of the format-specific selection of preset parameters together with general parameters in the preset parameter unit 28.

For creating the format-specific video sequence, based on the format-specific, the general parameters, possibly existing importancy factors and the activation properties of the elements 11, 12 and 15, the insertion units 29 can be realised as an export filter automatically creating the format-specific video sequence in response to a respective request for a reproduction platform 30 having a specific format.

If for the reproduction platforms 30 for example a format-specific parameter defines to use press buttons as representative for elements, but the general preset parameters for the element instructs to display a selectable text as representative, the insertion unit 29 from the contradictory preset parameters may select which representation will be used. Importancy factors may exist for activation properties as well as the preset parameters.

What is claimed is:

1. Method for computer-controlled administration of interactivity for an element of a video sequence, wherein the element is an audio, visual or content related element, the method comprising the steps:
recording or storing an activitability in time for the element;
creating an activatable object for a reproduction platform having a specific format for video sequences with activatable objects;
characterised in that:
the format specific creating is performed based on the activatability in time and preset parameters for activation properties,
wherein a positional arrangement of the activatable object is based on the preset parameters, and
different reproduction platforms are supported for the step of creating.

2. The method according to claim 1 characterised in that it is predetermined for the step of creating to use a selectable text or an activatable area as a representative of the element being positionally arranged independent from the element.

3. The method according to claim 1 characterised in that the activatability in time is administered separated from the video sequence.

4. The method according to claim 1 characterised in that activation properties for the element are administered separated from the video sequence.

5. The method according to claim 1 characterised in that the activation properties and the activatability in time is stored separated from each other in an external database, but associated to each other by reference.

6. The method according to claim 1 characterised in that the preset parameters for activation properties comprises general and format specific parameters, wherein the preset parameters are stored in an external database and the general parameters may be usable as activation properties in a plurality of video sequences.

7. The method according to claim 6 characterised in that the recording of the activatability in time is performed by setting time stamps in response to an action of a processing person upon reproduction of the video sequence.

8. The method according to claim 4 characterised in that the creating is realised by using an export filter, that evaluates or applies an importancy factor of the preset parameters and the activation properties for the video sequence.

9. Computer controlled apparatus comprising means to realise a method according to claim 1.

10. A storage medium comprising a computer program or an instruction sequence realising the method according to claim 1.
